(19) United States
(12) Patent Application Publication
(10) Pub. No.: US 2013/0005890 A1
(43) Pub. Date: Jan. 3, 2013

(54) THERMAL STABILIZATION OF POLYARYLENE SULFIDE COMPOSITIONS

(75) Inventors: Joachim C. Ritter, Wilmington, DE (US); Joel M. Pollino, Alpharetta, GA (US); Michael T. Pottiger, Media, PA (US); Yefim Brun, Wilmington, DE (US); Zheng-Zheng Huang, Wilmington, DE (US); John C. Howe, Bear, DE (US)

(73) Assignee: E I Du Pont De Nemours And Company, Wilmington, DE (US)

(21) Appl. No.: 13/634,969

(22) PCT Filed: Mar. 22, 2011
(86) PCT No.: PCT/US2011/029299

§ 371 Date: Sep. 14, 2012

Related U.S. Application Data
(60) Provisional application No. 61/316,044, filed on Mar. 22, 2010.

(51) Int. Cl. C08L 81/04; C08K 3/22; C08K 5/098

(52) U.S. Cl. 524/399

(57) ABSTRACT

Provided are novel compositions comprising a polyarylene sulfide and at least one tin additive comprising a branched tin(II) carboxylate selected from the group consisting of Sn(O₂CR)₂, Sn(O₂CR)(O₂CR′), Sn(O₂CR)(O₂CR″), and mixtures thereof, where the carboxylate moieties O₂CR and O₂CR′ independently represent branched carboxylate anions and the carboxylate moiety O₂CR″ represents a linear carboxylate anion. Articles comprising the novel compositions are also provided. In addition, methods to improve the thermal stability of polyarylene sulfides, and methods to improve the thermo-oxidative stability of polyarylene sulfides, through the use of the disclosed branched tin(II) carboxylates are provided. The polyarylene sulfide compositions are useful in various applications which require superior thermal resistance, chemical resistance, and electrical insulating properties.

### CROSS-REFERENCE TO RELATED APPLICATIONS

This application claims the benefit of priority of U.S. Provisional Application No, 61/316,044 filed on Mar. 22, 2010, which is herein incorporated by reference in its entirety.

### FIELD

This invention relates to polyarylene sulfide compositions and to methods of stabilizing them.

### BACKGROUND

In applications such as the production of fibers, films, nonwovens, and molded parts from polyarylene sulfide resins, it is desirable that the molecular weight and viscosity of the polymer resin remain substantially unchanged during processing of the polymer. Various procedures have been utilized to stabilize polyarylene sulfide compositions such as polyphenylene sulfide (PPS) against changes in physical properties during polymer processing.

U.S. Pat. No. 4,411,853 discloses that the heat stability of arylene sulfide resins is improved by the addition of an effective stabilizing amount of at least one organotin compound which retards curing and cross-linking of the resin during heating. A number of dialkyltin dicarboxylate compounds used as cure retarders and heat stabilizers are disclosed, as well as di-n-butyltin-S,S′-bis(isooctyl thioacetate) and di-n-butyltin-S,S′-bis(isooctyl-3-thiopropionate.

U.S. Pat. No. 4,418,029 discloses that the heat stability of arylene sulfide resins is improved by the addition of cure retarders comprising Group IIA or Group IIB metal salts of fatty acids represented by the structure [CH₃(CH₁₂)ₙCOO—]—₂M, where M is a Group IIA or Group IIB metal and n is an integer from 8 to 18. The effectiveness of zinc stearate, magnesium stearate, and calcium stearate is disclosed.

U.S. Pat. No. 4,426,479 relates to a chemically stabilized poly-p-phenylene sulfide resin composition and a film made thereof. The reference discloses that the PPS resin composition should contain at least one metal component selected from the group consisting of zinc, lead, magnesium, manganese, barium, and tin, in a total amount of from 0.05 to 40 wt %. These metal components may be contained in any form.

New polyarylene sulfide compositions exhibiting improved thermal and thermo-oxidative stability are continually sought, as are methods to provide improved thermal and thermo-oxidative stability to polyarylene sulfide compositions, especially polyphenylene sulfide compositions.

### SUMMARY

This invention provides a method to improve the thermal stability of a polyarylene sulfide, the method comprising combining a polyarylene sulfide with at least one tin additive comprising a branched tin(II) carboxylate selected from the group consisting of Sn(O₂₀R)₂, Sn(O₂CR)(O₂CR′), Sn(O₂CR)(O₂CR″), and mixtures thereof, where the carboxylate moieties O₂CR and O₂CR′ independently represent branched carboxylate anions and the carboxylate moiety O₂OR″ represents a linear carboxylate anion.

This invention provides a method to improve the stability of a polyarylene sulfide, the method comprising combining a polyarylene sulfide with at least one tin additive comprising a branched tin(II) carboxylate selected from the group consisting of Sn(O₂CR)₂, Sn(O₂CR)(O₂CR′), Sn(O₂CR)(O₂CR″), and mixtures thereof, where the carboxylate moieties O₂CR and O₂CR′ independently represent branched carboxylate anions and the carboxylate moiety O₂CR″ represents a linear carboxylate anion.

This invention relates to polyarylene sulfide compositions comprising at least one tin additive comprising a branched tin(II) carboxylate. The tin additive imparts improved thermal stability to the polyarylene sulfide compositions. In addition, the tin additive improves the thermo-oxidative stability of the polyarylene composition.

### BRIEF DESCRIPTION OF THE FIGURES

FIG. 1 shows a perspective view of fiber loops on a frame as used to age fiber samples in air in a convection oven.

### DETAILED DESCRIPTION

The present invention relates to compositions comprising a polyarylene sulfide and at least one tin additive comprising a branched tin(II) carboxylate selected from the group consisting of Sn(O₂CR)₂, Sn(O₂CR)(O₂CR′), Sn(O₂CR)(O₂CR″), and mixtures thereof, where the carboxylate moieties O₂CR and O₂CR′ independently represent branched carboxylate anions and the carboxylate moiety O₂CR″ represents a linear carboxylate anion. The present invention further relates to articles comprising the novel compositions. The present invention also relates to methods to improve the thermal stability of polyarylene sulfides through the use of the disclosed tin additives. Additionally, the present invention relates to methods to improve the thermo-oxidative stability of polyarylene sulfides through the use of the disclosed tin additives. The polyarylene sulfide compositions are useful in various applications which require superior thermal resistance, chemical resistance, and electrical insulating properties.

Where the indefinite article “a” or “an” is used with respect to a statement or description of the presence of a step in a process of this invention, it is to be understood, unless the statement or description explicitly provides to the contrary, that the use of such indefinite article does not limit the presence of the step in the process to one in number.

Where a range of numerical values is recited herein, unless otherwise stated, the range is intended to include the endpoints thereof, and all integers and fractions within the range. It is not intended that the scope of the invention be limited to the specific values recited when defining a range.

The following definitions are used herein and should be referred to for interpretation of the claims and the specification.

The term “PAS” means polyarylene sulfide.

The term “PPS” means polyphenylene sulfide.

The term “native” refers to a polymer which does not contain any additives.

The term “secondary carbon atom” means a carbon atom that is bonded to two other carbon atoms with single bonds.

The term “tertiary carbon atom” means a carbon atom that is bonded to three other carbon atoms with single bonds.

The term “thermal stability”, as used herein, refers to the degree of change in the weight average molecular weight of a PAS polymer induced by elevated temperatures in the absence of oxygen. As the thermal stability of a given PAS polymer improves, the degree to which the polymer's weight average molecular weight changes over time decreases. Generally, in the absence of oxygen, changes in molecular weight are often considered to be largely due to chain scission, which typically decreases the molecular weight of a PAS polymer.

The term “thermo-oxidative stability”, as used herein, refers to the degree of change in the weight average molecular weight of a PAS polymer induced by elevated temperatures in the presence of oxygen. As the thermo-oxidative stability of a given PAS polymer improves, the degree to which the polymer's weight average molecular weight changes over time decreases. Generally, in the presence of oxygen, changes in molecular weight may be due to a combination of oxidation of the polymer and chain scission. As oxidation of the polymer typically results in cross-linking, which increases molecular weight, and chain scission typically decreases the molecular weight, changes in molecular weight of a polymer at elevated temperatures in the presence of oxygen may be challenging to interpret.

The term “° C.” means degrees Celsius.

The term “kg” means kilogram(s).

The term “g” means gram(s).

The term “mg” means milligram(s).

The term “mol” means mole(s).

The term “s” means second(s).

The term “min” means minute(s).

The term “hr” means hour(s).

The term “rpm” means revolutions per minute.

The term “rad” means radians.

The term “Pa” means pascals.

The term “psi” means pounds per square inch

The term “mL” means milliliter(s).

The term “ft” means foot.

The term “weight percent” as used herein refers to the weight of a constituent of a composition relative to the entire weight of the composition unless otherwise indicated, Weight percent is abbreviated as “wt %”.

Polyarylene sulfides (PAS) include linear, branched or cross linked polymers that include arylene sulfide units. Polyarylene sulfide polymers and their synthesis are known in the art and such polymers are commercially available.

Exemplary polyarylene sulfides useful in the invention include polyarylene thioethers containing repeat units of the formula —[(Ar¹)ₙ—X]ₘ—[(Ar²)ᵢ—Y]ⱼ—(Ar³)ₖ—Z]ₗ—[(Ar⁴)ₒ—W]ₚ— wherein Ar¹, Ar², Ar³, and Ar⁴ are the same or different and are arylene units of 6 to 18 carbon atoms; W, X, Y, and Z are the same or different and are bivalent linking groups selected from —SO₂—, —S—, —SO—, —CO—, —O—, —COO— or alkylene or alkylidene groups of 1 to 6 carbon atoms and wherein at least one of the linking groups is —S—; and n, m, i, j, k, l, o, and p are independently zero or 1, 2, 3, or 4, subject to the proviso that their sum total is not less than 2. The arylene units Ar¹, Ar², Ar³, and Ar⁴ may be selectively substituted or unsubstituted. Advantageous arylene systems are phenylene, biphenylene, naphthylene, anthracene and phenanthrene. The polyarylene sulfide typically includes at least 30 mol %, particularly at least 50 mol % and more particularly at least 70 mol % arylene sulfide (—S—) units. Preferably the polyarylene sulfide polymer includes at least 85 mol % sulfide linkages attached directly to two aromatic rings. Advantageously the polyarylene sulfide polymer is polyphenylene sulfide (PPS), defined herein as containing the phenylene sulfide structure —(C₆H₄—S)ₙ— (wherein n is an integer of 1 or more) as a component thereof.

A polyarylene sulfide polymer having one type of arylene group as a main component can be preferably used. However, in view of processability and heat resistance, a copolymer containing two or more types of arylene groups can also be used. A PPS resin comprising, as a main constituent, a p-phenylene sulfide recurring unit is particularly preferred since it has excellent processability and is industrially easily obtained. In addition, a polyarylene ketone sulfide, polyarylene ketone ketone sulfide, polyarylene sulfide sulfone, and the like can also be used.

Specific examples of possible copolymers include a random or block copolymer having a p-phenylene sulfide recurring unit and an m-phenylene sulfide recurring unit, a random or block copolymer having a phenylene sulfide recurring unit and an arylene ketone sulfide recurring unit, a random or block copolymer having a phenylene sulfide recurring unit and an arylene ketone ketone sulfide recurring unit, and a random or block copolymer having a phenylene sulfide recurring unit and an arylene sulfone sulfide recurring unit.

The polyarylene sulfides may optionally include other components not adversely affecting the desired properties thereof. Exemplary materials that could be used as additional components would include, without limitation, antimicrobials, pigments, antioxidants, surfactants, waxes, flow promoters, particulates, and other materials added to enhance processability of the polymer. These and other additives can be used in conventional amounts.

As noted above, PPS is an example of a polyarylene sulfide. PPS is an engineering thermoplastic polymer that is widely used for film, fiber, injection molding, and composite applications due to its high chemical resistance, excellent mechanical properties, and good thermal properties. However, the thermal and oxidative stability of PPS is considerably reduced in the presence of air and at elevated temperature conditions. Under these conditions, severe degradation can occur, leading to the embitterment of PPS material and severe loss of strength. Improved thermal and oxidative stability of PPS at elevated temperatures and in the presence of air are desired.

The polyarylene sulfide composition may comprise at least one tin additive comprising a branched tin(II) carboxylate selected from the group consisting of Sn(O₂CR)₂, Sn(O₂CR)(O₂CR′), Sn(O₂OR)(O₂CR″), and mixtures thereof, where the carboxylate moieties O₂CR and O₂CR′ independently represent branched carboxylate anions and the carboxylate moiety O₂OR″ represents a linear carboxylate anion. In one embodiment, the branched tin(II) carboxylate comprises Sn(O₂CR)₂, Sn(O₂CR)(O₂CR), or a mixture thereof. In one embodiment, the branched tin(II) carboxylate comprises Sn(O₂CR)₂. In one embodiment, the branched tin(II) carboxylate comprises Sn(O₂CR)(O₂CR′). In one embodiment, the branched tin(II) carboxylate comprises Sn(O₂CR)(O₂CR″).

Optionally, the tin additive may further comprise a linear tin(II) carboxylate Sn(O₂CR″)₂. Generally, the relative amounts of the branched and linear tin(II) carboxylates are selected such that the sum of the branched carboxylate moieties [O₂CR+O₂CR′] is at least about 25% on a molar basis of the total carboxylate moieties [O₂CR+O₂CR′+O₂CR″] contained in the additive. For example, the sum of the branched carboxylate moieties may be at least about 33%, or at least about 40%, or at least about 50%, or at least about 66%, or at least about 75%, or at least about 90%, of the total carboxylate moieties contained in the tin additive.

In one embodiment, the radicals R and R′ both comprise from 6 to 30 carbon atoms and both contain at least one secondary or tertiary carbon. The secondary or tertiary carbon(s) may be located at any position(s) in the carboxylate moieties O₂CR and O₂CR′, for example in the position α to the carboxylate carbon, in the position ω to the carboxylate carbon, and at any intermediate position(s). The radicals R and R′ may be unsubstituted or may be optionally substituted with inert groups, for example with fluoride, chloride, bromide, iodide, nitro, hydroxyl, and carboxylate groups. Examples of suitable organic R and R′ groups include aliphatic, aromatic, cycloaliphatic, oxygen-containing heterocyclic, nitrogen-containing heterocyclic, and sulfur-containing heterocyclic radicals. The heterocyclic radicals may contain carbon and oxygen, nitrogen, or sulfur in the ring structure.

In one embodiment, the radical R″ is a primary alkyl group comprising from 6 to 30 carbon atoms, optionally substituted with inert groups, for example with fluoride, chloride, bromide, iodide, nitro, hydroxyl, and carboxylate groups. In one embodiment, the radical R″ is a primary alkyl group comprising from 6 to 20 carbon atoms.

In one embodiment, the radicals R or R″ independently or both have a structure represented by Formula (I),

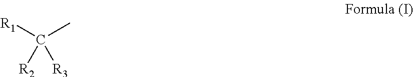

wherein R₁, R₂, and R₃ are independently:

H;

a primary, secondary, or tertiary alkyl group having from 6 to 18 carbon atoms, optionally substituted with fluoride, chloride, bromide, iodide, nitro, hydroxyl, and carboxyl groups;

an aromatic group having from 6 to 18 carbon atoms, optionally substituted with alkyl, fluoride; chloride, bromide, iodide, nitro, hydroxyl, and carboxyl groups; and

a cycloaliphatic group having from 6 to 18 carbon atoms, optionally substituted with fluoride, chloride, bromide, iodide, nitro, hydroxyl, and carboxyl groups;

with the proviso that when R₂ and R₃ are H, R₁ is:

a secondary or tertiary alkyl group having from 6 to 18 carbon atoms, optionally substituted with fluoride, chloride, bromide, iodide, nitro, hydroxyl, and carboxyl groups;

an aromatic group having from 6 to 18 carbons atoms and substituted with a secondary or tertiary alkyl group having from 6 to 18 carbon atoms, the aromatic group and/or the secondary or tertiary alkyl group being optionally substituted with fluoride, chloride, bromide, iodide, nitro, hydroxyl, and carboxyl groups; and

a cycloaliphatic group having from 6 to 18 carbon atoms, optionally substituted with fluoride, chloride, bromide, iodide, nitro, hydroxyl, and carboxyl groups.

In one embodiment, the radicals R or R′ or both have a structure represented by Formula (I), and R₃ is H.

In another embodiment, the radicals R or R′ or both have a structure represented by Formula (II),

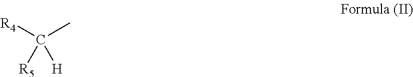

wherein

R₄ is a primary, secondary, or tertiary alkyl group having from 4 to 6 carbon atoms, optionally substituted with fluoride, chloride, bromide, iodide, nitro, and hydroxyl groups; and

R₅ is a methyl, ethyl, n-propyl, sec-propyl, n-butyl, sec-butyl, or tert-butyl group, optionally substituted with fluoride, chloride, bromide, iodide, nitro, and hydroxyl groups.

In one embodiment, the radicals R and R′ are the same and both have a structure represented by Formula (II), where R₄ is n-butyl and R₅ is ethyl. This embodiment describes the branched tin(II) carboxylate tin(II) 2-ethylhexanoate, also referred to herein as tin(II) ethylhexanoate.

The tin(II) carboxylate(s) may be obtained commercially, or may be generated in situ from an appropriate source of tin(II) cations and the carboxylic acid corresponding to the desired carboxylate(s). The tin(II) additive may be present in the polyarylene sulfide at a concentration sufficient to provide improved thermo-oxidative and/or thermal stability. In one embodiment, the tin(II) additive may be present at a concentration of about 10 weight percent or less, based on the weight of the polyarylene sulfide. For example, the tin(II) additive may be present at a concentration of about 0.01 weight percent to about 5 weight percent, or for example from about 0.25 weight percent to about 2 weight percent. Typically, the concentration of the tin(II) additive may be higher in a master batch composition, for example from about 5 weight percent to about 10 weight percent, or higher. The tin(H) additive may be added to the molten or solid polyarylene sulfide as a solid, as a slurry, or as a solution.

In one embodiment, the polyarylene sulfide composition further comprises at least one zinc(II) compound and/or zinc metal [Zn(0)]. The zinc(II) compound may be an organic compound, for example zinc stearate, or an inorganic compound such as zinc sulfate or zinc oxide, as long as the organic or inorganic counter ions do not adversely affect the desired properties of the polyarylene sulfide composition. The zinc(II) compound may be obtained commercially, or may be generated in situ. Zinc metal may be used in the composition as a source of zinc(II) ions, alone or in conjunction with at least one zinc(II) compound. In one embodiment the zinc(II) compound is selected from the group consisting of zinc oxide, zinc stearate, and mixtures thereof.

The zinc(II) compound and/or zinc metal may be present in the polyarylene sulfide at a concentration of about 10 weight percent or less, based on the weight of the polyarylene sulfide. For example, the zinc(II) compound and/or zinc metal may be present at a concentration of about 0.01 weight percent to about 5 weight percent, or for example from about 0.25 weight percent to about 2 weight percent. Typically, the concentration of the zinc(II) compound and/or zinc metal may be higher in a master batch composition, for example from about 5 weight percent to about 10 weight percent, or higher. The at least one zinc(II) compound and/or zinc metal may be added to the molten or solid polyarylene sulfide as a solid, as a slurry, or as a solution. The zinc(II) compound and/or zinc metal may be added together with the tin(II) additive or separately.

U.S. Pat. Nos. 3,405,073 and 3,489,702 relate to compositions useful in the enhancement of the resistance of ethylene sulfide polymers to heat deterioration. Such polymers are composed of ethylene sulfide units linked in a long chain (CH₂CH₂—S)ₙ, where n represents the number of such units in the chain, and are thus of the nature of polymeric ethylene thioethers. The references note that the utility of these polymers as plastic materials for industrial applications is seriously limited, however, due to their lack of adequate mechanical strength. The references disclose that an organotin compound having organic radicals attached to tin through oxygen, such as a tin carboxylate, phenolate or alcoholate, is employed to enhance resistance to heat deterioration of ethylene sulfide polymers. The references note that the efficacy of the organotin compounds is frequently enhanced by a compound of another polyvalent metal, or another tin compound. The second polyvalent metal can be any metal selected from Groups II to VIII of the Periodic Table. There is a difference in the chemical reactivity and physical properties of ethylene sulfide polymers as compared to polyarylene sulfides. Applicants have discovered, however, that various additives as described herein have the same effect in polyarylene sulfides as they do in ethylene sulfide polymers.

Articles comprising the polyarylene sulfide and at least one tin additive comprising a branched tin(II) carboxylate as described herein above include a fiber, a nonwoven fabric, a film, a coating, and a molded part. Such a fiber or nonwoven fabric may be useful, for example, in filtration media employed at elevated temperatures, as in filtration of exhaust gas from incinerators or coal fired boilers with bag filters. Coatings comprising the novel polyarylene sulfide composition may be used on wires or cables, particularly those in high temperature, oxygen-containing environments.

In one embodiment of the invention, a method to improve the thermal stability of a polyarylene sulfide is provided. The method comprises combining a polyarylene sulfide with a sufficient amount of at least one tin additive comprising a branched tin(II) carboxylate selected from the group consisting of Sn(O₂CR)₂, Sn(O₂CR)(O₂CR), Sn(O₂CR)(O₂CR″), and mixtures thereof, where the carboxylate moieties O₂CR and O₂CR′ independently represent branched carboxylate anions and the carboxylate moiety O₂CR″ represents a linear carboxylate anion, and wherein the radicals R, R′, and R″ are as described herein above. The tin additive, optionally in combination with a zinc(II) compound or zinc metal, provides improved thermal stability to the polyarylene sulfide composition, meaning that at elevated temperatures in the absence of oxygen, changes over time in the weight average molecular weight of the polymer are decreased, relative to changes in the weight average molecular weight of native PPS over the same time and at the same temperature. Improved thermal stability is desired, for example, for polymer melts which are typically processed under conditions where exposure to oxygen is minimal and the time at elevated temperatures is also minimal.

In another embodiment of the invention, a method to improve the thermo-oxidative stability of a polyarylene sulfide is provided. The method comprises combining a polyarylene sulfide with a sufficient amount of at least tin additive comprising a branched tin(II) carboxylate selected from the group consisting of Sn(O₂CR)₂, Sn(O₂CR)(O₂CR′), Sn(O₂CR)(O₂CR″), and mixtures thereof, where the carboxylate moieties O₂CR and O₂CR′ independently represent branched carboxylate anions and the carboxylate moiety O₂OR″ represents a linear carboxylate anion and wherein the radicals R, R′, and R″ are as described above. The tin additive, optionally in combination with a zinc(II) compound or zinc metal, provides improved thermo-oxidative stability to the polyarylene sulfide composition, meaning that at elevated temperatures in the presence of oxygen, changes over time in the weight average molecular weight of the polymer are decreased, relative to changes in the weight average molecular weight of native PPS over the same time and at the same temperature. Improved thermal stability is particularly desired, for example, for articles comprising PPS in the solid state which are used under conditions where exposure to oxygen at elevated temperatures may occur for an extended period of time. An example of such an article is a nonwoven fabric composed of a PPS fiber and used as a bag filter to collect dust emitted from incinerators, coal fired boilers, and metal melting furnaces.

### EXAMPLES

The present invention is further defined in the following examples. It should be understood that these examples, while indicating preferred embodiments of the invention, are given by way of illustration only. From the above discussion and these examples, one skilled in the art can ascertain the essential characteristics of this invention, and without departing from the spirit and scope thereof, can make various changes and modifications of the invention to adapt it to various uses and conditions.

Examples 1 through 3 and Comparative Examples A through demonstrate PPS compositions in the form of pellets. Examples 4 through 6 and Comparative Examples E and F demonstrate PPS compositions in the form of fibers.

### Materials

The following materials were used in the examples. All commercial materials were used as received unless otherwise indicated. Fortron® 309 polyphenylene sulfide and Fortron® 317 polyphenylene sulfide were obtained from Ticona (Florence, Ky.). Tin(II) 2-ethylhexanoate (90%) and zinc oxide (99%) were obtained from Sigma-Aldrich (St. Louis, Mo.). Tin(II) stearate (98%) was obtained from Acros Organics (Morris Plains, N.J.). Zinc stearate (99%) was obtained from Honeywell Reidel-de Haen (Seelze, Germany).

Tin(II) 2-ethylhexanoate is also referred to herein as ti (II) ethylhexanoate.

For each Example and Comparative Example, different samples of the composition to be evaluated were used for complex viscosity and for molecular weight measurements.

### Analytical Methods

### Complex Viscosity Measurements

The thermal stability of PPS compositions was assessed by measuring in situ changes in complex viscosity under nitrogen as a function of time. Complex viscosity was measured at 300° C. under nitrogen in accordance with ASTM D 4440 using a Malvern controlled-stress rotational rheometer equipped with an extended temperature cell (ETC) forced convection oven and 25 mm parallel plates with smooth surfaces. Plate temperature was calibrated using a disc made of nylon with a thermocouple embedded in the middle. Disks with a diameter of 25 mm and a thickness of 1.2 mm were prepared from pellets of the compositions of the Examples and the Comparative Examples by compression molding under vacuum at a temperature of 290° C. using a Dake heated laboratory press.

To perform complex viscosity measurements, a molded disk of the PPS composition was inserted between the parallel plates preheated to 300° C., the door of the forced convection oven was closed, the gap was changed to around 3200 μm to prevent curling of the disk, and the oven temperature was allowed to re-equilibrate to 300° C. The gap was then changed from 3200 to 1050 μm, the oven was opened, the edges of the sample were carefully trimmed, the oven was closed, the oven temperature was allowed to re-equilibrate to 300° C., the gap was adjusted to 1000 μm, and the measurement started. A time sweep was performed at a frequency of 6.283 rads using a strain of 10%. The measurement was performed in duplicate with a fresh sample loading each time and the average values are reported in the Tables.

Viscosity retention was calculated as follows and expressed as a percentage:

Visc. retention (%)=[1−[(Visc(initial)−Visc(final))/Visc(initial)]]×100

Where Visc (initial) is the viscosity of the sample measured as 180 s after the start of the test and Visc (final) is the viscosity of the sample measured at 3600 s after the start of the test. Visc (initial) and Visc (comp) are measured under the same conditions.

### Molecular Weight Measurements

The thermal stability of PPS compositions was also assessed by measuring changes in molecular weight (Mw) under nitrogen as a function of time. To assess changes in molecular weight, samples were heat-treated in nitrogen and compared with untreated samples. To heat-treat a sample, a 12″ aluminum block containing 17×28 mm holes was preheated in a nitrogen-purged dry box to 320° C. using an IKA hotplate. Pellets (0.5 g) of the compositions of the Examples and the Comparative Examples were placed in 40 mL vials (26 mm×95 mm) and inserted into the preheated block for 2 h, removed, and allowed to cool to room temperature. The resulting monolithic mass of heat-treated polymer was subsequently removed from each vial by immersion in liquid nitrogen followed by breaking the vial with a hammer after removal from the liquid nitrogen.

The molecular weights of the heat-treated and non-heat-treated samples were measured using an integrated multidetector SEC system PL-220™ from Polymer Laboratories Ltd., now a part of Varian Inc. (Church Stratton, UK). Constant temperature was maintained across the entire path of a polymer solution from the injector through the four on-line detectors: 1) a two-angle light scattering photometer, 2) a differential refractometer, 3) a differential capillary viscometer, and 4) an evaporative light scattering photometer (ELSD). The system was run with closed valves for the ELSD detector, so that only traces from the refractometer, viscometer and light scattering photometer were collected. Three chromatographic columns were used: two Mix-B PL-Gel columns and one 500A PL Gel column from Polymer Labs (10 μm particle size). The mobile phase was comprised of 1-chloronaphthalene (1-CNP) (Acros Organics), which was filtered through a 0.2 micron PTFE membrane filter prior to use. The oven temperature was set to 210° C.

Typically, a PPS sample was dissolved for 2 hours in 1-CNP at 250° C. with continuous moderate agitation without filtration (Automatic sample preparation system PL 260 ™ from Polymer Laboratories). Subsequently, the hot sample solution was transferred into a hot (220° C.) 4 mL injection valve at which point it was immediately injected and eluted in the system. The following set of chromatographic conditions was employed: 1-CNP temperature: 220° C. at injector, 210° C. at columns and detectors; flow rate: 1 mL/min, sample concentration: 3 mg/mL, injection volume: 0.2 mL, run time: 40 min. Molecular weight distribution (MWD) and average molecular weights of PPS were then calculated using a multidetector SEC method implemented in Empower™ 2.0 Chromatography Data Manager from Waters Corp. (Milford, Mass.).

Molecular weight retention was calculated as follows and expressed as a percentage:

Mw Retention (%)=[1−[(Mw (initial)−Mw(final))/Mw(initial)]]×100

where Mw (initial) is the molecular weight of the composition at the start of the thermal stability test and Mw (final) is the molecular weight of the composition after aging for 2 hours at 320° C. in nitrogen.

### Differential Scanning Calorimetry Measurements

The thermo-oxidative stability of PPS compositions was assessed by measuring changes in melting point (Tm) as a function of exposure time in air. In one analysis method, solid PPS compositions were exposed in air at 250° C. for 10 days. In another analysis method, molten PPS compositions were exposed in air at 320° C. for 3 hours. In each analysis method, melting point retention was quantified and reported as Δ Tm (° C.). Lower Δ Tm (° C.) values indicated higher thermo-oxidative stability.

In the 250° C. method, samples (1-5 g) of the compositions of the Examples and the Comparative Examples were weighed and placed in a 2 inch circular aluminum pan on the middle rack of a 250° C. preheated convection oven with active circulation. After 10 days of air aging the samples were removed and stored for evaluation by differential scanning calorimetry (DSC). DSC was performed using a TA instruments 0100 equipped with a mechanical cooler. Samples were prepared by loading 8-12 mg of air-aged polymer into a standard aluminum DSC pan and crimping the lid. The temperature program was designed to erase the thermal history of the sample by first heating it above its melting point from 35° C. to 320° C. at 10° C./min and then allowing the sample to re-crystallize during cooling from 320° C. to 35° C. at 10° C./min. Reheating the sample from 35° C. to 320° C. at 10° C./min afforded the melting point of the air-aged sample, which was recorded and compared directly to the melting point of a non-aged sample of the same composition. The entire temperature program was carried out under a nitrogen purge at a flow rate of 50 mL/min. All melting points were quantified using TA's Universal Analysis software via the software's linear peak integration function.

In the 320° C. method, samples (8-12 mg) of the compositions of the Examples and the Comparative Examples were placed inside a standard aluminum DSC pan without a lid. DSC was performed using a TA instruments Q100 equipped with a mechanical cooler. The temperature program was designed to melt the polymer under nitrogen, expose the sample to air at 320° C. for 20 min, crystallize the air-exposed sample under nitrogen, and then reheat the sample to identify changes in the melting point. Thus, each sample was heated from 35° C. to 320° C. at 20° C./min under nitrogen (flow rate: 50 mL/min) and held isothermally at 320° C. for 5 min, at which point the purge gas was switched from nitrogen to air (flow 50 mL/min) while maintaining a temperature of 320° C. for 180 minutes. Subsequently, the purge gas was switched back from air to nitrogen (flow rate: 50 mL/min) and the sample was cooled from 320° C. to 35° C. at 10° C./min and then reheated from 35° C. to 320° C. at 10° C./min to measure the melting point of the air-exposed material. All melt curves were bimodal. The melting point of the lower melt was quantified using TA's Universal Analysis software via the software's inflection of the onset function.

In the Tables, “Ex” means “Example”, “Comp Ex” means “Comparative Example”, “@” means “at”, “MW” means “molecular weight”, “Tm” means “melting point”, and “Δ” means “difference”.

Complex viscosity and weight average molecular weight values are reported as average value+/−uncertainty. Following standard convention, the uncertainty was rounded to 1 significant figure and the average value was rounded to the same number of decimal places as the uncertainty. The average values reported in the Table are the mean obtained from a minimum of two runs and the uncertainty is the standard error of the mean. For the weight average molecular weight the uncertainty is 1000 g/mol and for the complex viscosity the uncertainty is 10 Pa·s.

### Example

### PPS Containing Tin(II) Ethylhexanoate

This Example shows the results for tin(II) ethylhexanoate as an additive in polyphenylene sulfide. A PPS composition containing 0.58 weight percent (0.014 mol/Kg) tin 2-ethylhexanoate was prepared as follows. Fortron® 309 PPS (700 g), Fortron® 317 PPS (300 g), and tin(II) ethylhexanoate (6.48 g) were combined in a glass jar, manually mixed, and placed on a Stoneware bottle roller for 5 min. The resultant mixture was subsequently melt compounded using a Coperion 18 mm intermeshing co-rotating twin-screw extruder. The conditions of extrusion included a maximum barrel temperature of 300° C., a maximum melt temperature of 310° C., screw speed of 300 rpm, with a residence time of approximately 1 minute and a die pressure of 14-15 psi at a single strand die. The strand was frozen in a 6 ft tap water trough prior to being pelletized by a Conair chopper to give a pellet count of 100-120 pellets per gram. 896 g of the pelletized composition was obtained.

The pelletized composition was evaluated for thermal and thermo-oxidative stability using the analytical techniques described above. Results are presented in Tables 1, 2, 3, and 4.

### Example 2

### PPS Containing Tin(II) Ethylhexanoate and Zinc Oxide

This Example shows the results for tin(II) ethylhexanoate and zinc oxide as additives in polyphenylene sulfide. A PPS composition containing 0.58 weight percent (0.014 mol/Kg) tin(II) ethylhexanoate and 0.13 weight percent (0.016 mol/Kg) zinc oxide was prepared as described in Example 1, except that 6.48 grams of tin(II) ethylhexanoate and 1.30 grams of zinc oxide were combined with 700 g Fortran® 309 PPS and 300 g Fortran® 317 PPS. 866 Grams of the pelletized composition were obtained.

The pelletized composition was evaluated for thermal and thermo-oxidative stability using the analytical techniques described above. Results are presented in Tables 1, 2, 3, and 4.

### Example 3

### PPS Containing Tin(II) Ethylhexanoate and Zinc Stearate

This Example shows the results for tin(II) ethylhexanoate and zinc stearate as additives in polyphenylene sulfide. A PPS composition containing 0.58 weight percent (0.014 mol/Kg) tin(II) ethylhexanoate and 1.0 weight percent (0.016 mol/Kg) zinc stearate was prepared as described in Example 1, except that 6.48 grams of tin(II) ethylhexanoate and 10.12 grams of zinc stearate were combined with 700 g of Fortron® 309 PPS and 300 g of Fortron® 317 PPS. 866 Grams of the pelletized composition were obtained.

The pelletized composition was evaluated for thermal and thermo-oxidative stability using the analytical techniques described above. Results are presented in Tables 1, 2, 3, and 4.

### Comparative Example A

### PPS Control (No Additives)

This Comparative Example is a control showing the results of polyphenylene sulfide without an additive, which is referred to as native PPS. A PPS composition was prepared as described in Example 1 using 700 g Fortron® 309 PPS and 300 g Fortron® 317 PPS but no other compounds were added. 829 Grams of the pelletized composition were obtained.

The pelletized composition was evaluated for thermal and thermo-oxidative stability using the analytical techniques described above. Results are presented in Tables 1, 2, 3, and 4.

### Comparative Example B

### PPS Containing Zinc Stearate

This Comparative Example shows the results for zinc stearate as an additive in polyphenylene sulfide, A PPS composition containing 1.0 weight percent (0.016 mol/Kg) zinc stearate was prepared as described in Example 1, except that 10.12 grams of zinc stearate were combined with 700 g of Fortron® 309 PPS and 300 g of Fortron® 317 PPS. 784 Grams of the pelletized composition were obtained.

The pelletized composition was evaluated for thermal and thermo-oxidative stability using the analytical techniques described above. Results are presented in Tables 1, 2, 3, and 4.

### Comparative Example C

### PPS Containing Tin Stearate

This Comparative Example shows the results for tin stearate as an additive in polyphenylene sulfide. A PPS composition containing 1.1 weight percent (0.016 mol/Kg) tin stearate was prepared as described in Example 1, except that 10.97 grams of tin stearate were combined with 700 g of Fortron® 309 PPS and 300 g of Fortron® 317 PPS. 797 Grams of the pelletized composition were obtained.

The pelletized composition was evaluated for thermal and thermo-oxidative stability using the analytical techniques described above. Results are presented in Tables 1, 2, 3, and 4.

### Comparative Example D

### PPS Containing Zinc Stearate and Tin Stearate

This Comparative Example shows the results for zinc stearate and tin stearate as co-additives in polyphenylene sulfide. A PPS composition containing 1.0 weight percent (0.016 mol/Kg) zinc stearate and 1.1 weight percent (0.016 mol/Kg) tin stearate was prepared as described in Example 1, except that 10.12 grams of zinc stearate and 10.97 grams of tin stearate were combined with 700 g of Fortron® 309 PPS and 300 g of Fortran® 317 PPS. 857 Grams of the pelletized composition were obtained.

The pelletized composition was evaluated for thermal and thermo-oxidative stability using the analytical techniques described above. Results are presented in Tables 1, 2, 3, and 4.

TABLE 1
Viscosity Data for Samples Evaluated at 300° C. Under Nitrogen

| | | Complex | Complex | |
|---|---|---|---|---|
| | | Viscosity | Viscosity | Viscosity |
| | | @ 180 s | @ 3600 s | Retention |
| Sample | Additive(s) | (Pa-s) | (Pa-s) | (%) |
| Ex 1 | tin ethylhexanoate | 120 | 110 | 92 |
| Ex 2 | tin ethylhexanoate + | 140 | 120 | 86 |
| | zinc oxide | | | |
| Ex 3 | tin ethylhexanoate + | 120 | 110 | 92 |
| | zinc stearate | | | |
| Comp Ex A | — | 250 | 160 | 64 |
| Comp Ex B | zinc stearate | 190 | 170 | 89 |
| Comp Ex C | tin stearate | 110 | 80 | 73 |
| Comp Ex D | tin stearate + zinc | 120 | 90 | 75 |
| | stearate | | | |

The complex viscosity data in Table 1 demonstrate improved thermal stability for the compositions of the Examples, which have higher viscosity retention percentages than Comparative Example A, the native PPS sample. After 1 hour at 320° C., viscosity retention for the compositions containing branched tin(II) carboxylates was at least 86% whereas the control was only 64%. The viscosity retention of Examples 1, 2, and 3 was also greater than the viscosity retention of Comparative Examples C and D, and about comparable or better than the viscosity retention of Comparative Example B.

TABLE 2
Molecular Weight Data for Samples Aged
at 320° C. for 2 Hours Under Nitrogen

| | | MW of | MW after | |
|---|---|---|---|---|
| | | non-heat | 2 hrs at | MW |
| | | treated sample | 320° C. | Reten- |
| Sample | Additive(s) | (g/mol) | (g/mol) | tion (%) |
| Ex 1 | tin ethylhexanoate | 57,000 | 49,000 | 86 |
| Ex 2 | tin ethylhexanoate + | 59,000 | 51,000 | 86 |
| | zinc oxide | | | |
| Ex 3 | tin ethylhexanoate + | 58,000 | 54,000 | 93 |
| | zinc stearate | | | |
| Comp Ex A | — | 60,000 | 46,000 | 77 |
| Comp Ex B | zinc stearate | 60,000 | 57,000 | 95 |
| Comp Ex C | tin stearate | 60,000 | 46,000 | 77 |
| Comp Ex D | tin stearate + zinc | 60,000 | 52,000 | 87 |
| | stearate | | | |

The molecular weight data in Table 2 demonstrate improved thermal stability for the compositions of the Examples, which have higher molecular weight retention percentages than Comparative Example A, the native PPS sample. After 2 hours at 320° C., molecular weight retention for the compositions containing branched tin(II) carboxylates was at least 86% whereas the control was only 77%.

TABLE 3
Melting Point (Tm) Data for Samples
Aged 10 Days at 250° C. In Air

| | | Tm initial | Tm final | Δ Tm |
|---|---|---|---|---|
| Sample | Additive(s) | (° C.) | (° C.) | (° C.) |
| Ex 1 | tin ethylhexanoate | 284 | 260 | 24 |
| Ex 2 | tin ethylhexanoate + zinc | 284 | 276 | 8 |
| | oxide | | | |
| Ex 3 | tin ethylhexanoate + zinc | 286 | 277 | 9 |
| | stearate | | | |
| Comp Ex A | — | 284 | 261 | 23 |
| Comp Ex B | zinc stearate | 285 | 267 | 18 |
| Comp Ex C | tin stearate | 284 | 257 | 27 |
| Comp Ex D | tin stearate + zinc stearate | 285 | 268 | 17 |

With melting point data, smaller changes (lower Δ Tm values) represent greater thermo-oxidative stability. In Table 3, the Δ Tm data obtained after 10 days of air exposure at 250° C. in the solid state demonstrate improved thermo-oxidative stability for PPS pellets comprising both tin ethylhexanoate and zinc(II) compounds as compared to solid PPS compositions comprising only tin ethylhexanoate or no additives at all. For Example 1, Δ Tm was 24° C. whereas Δ Tm for Examples 2 and 3 were 8° C. and 9° C., respectively. In comparison, native PPS (Comparative Example A) had a Δ Tm of 23° C. The Δ Tm for PPS comprising linear tin stearate (Comparative Example C) was higher than that of Comparative Example A or Example 1, and Δ Tm for the combination of tin stearate and zinc stearate (Comparative Example D) was 17° C., significantly higher than that for Examples 2 and 3.

TABLE 4
Melting Point (Tm) Data for Samples
Aged 3 Hours at 320° C. In Air

| | | Tm initial | Tm final | Δ Tm |
|---|---|---|---|---|
| Sample | Additive(s) | (° C.) | (° C.) | (° C.) |
| Ex 1 | tin ethylhexanoate | 284 | 254 | 30 |
| Ex 2 | tin ethylhexanoate + zinc | 284 | 259 | 25 |
| | oxide | | | |
| Ex 3 | tin ethylhexanoate + zinc | 286 | 261 | 25 |
| | stearate | | | |
| Comp Ex A | — | 284 | 249 | 35 |
| Comp Ex B | zinc stearate | 285 | 260 | 25 |
| Comp Ex C | tin stearate | 284 | 247 | 37 |
| Comp Ex D | tin stearate + zinc stearate | 285 | 262 | 23 |

In Table 4, the Δ Tm data obtained after 3 h of air exposure at 320° C. in the molten phase demonstrate improved thermo-oxidative stability for molten PPS comprising both tin ethylhexanoate and a zinc compound as compared to PPS compositions comprising only tin ethylhexanoate or no additives at all. For Example 1, Δ Tm was 30° C. whereas Δ Tm for Examples 2 and 3 were both 25° C. In comparison, native PPS (Comparative Example A) had a Δ Tm of 35° C. The Δ Tm for PPS comprising linear tin stearate (Comparative Example C) was higher than that of Comparative Example A or Example 1.

The fiber samples of Examples 4 through 6 and Comparative Examples E and F were obtained using the general procedure described below. The additive(s), amount(s) of additive(s), and draw ratios used are indicated in Table 5. The fibers were then aged in air as described below and their molecular weights measured using the analytical method described above.

Fortran® 309 and Fortron 317 PPS pellets were dried for 16 hours at 120° C. in a vacuum oven with a dry nitrogen sweep. Dried Fortron® 309 PPS pellets (30 parts by weight) and Fortron® 317 PPS pellets (70 parts by weight) were combined with the additive and its amount indicated in Table 5 and mixed in a polyethylene bag. The mixture was metered into a Werner and Pfleiderer 28 mm twin screw extruder and spun through a 34-hole spinneret orifice of 0.012 inch (0.030 mm) diameter and 0.048 inch (1.22 mm) length to produce fibers. The extruder was heated as follows: in the feed zone to 190° C., in the melt zones at 275° C. then 285° C., in the transfer zones at 285° C., and in the Zenith pumps (Zenith Pumps, Monroe, N.C.) at 285° C. The molten polymer was transferred to the spinneret pack block at 290° C. A ring heater was used at 295° C. around the pack nut holding the spinneret.

The speed of the gear pump was preset so as to supply 42 g/min of the PPS composition to the spinneret. The polymer stream was filtered through five 200 mesh screens sandwiched between 50 mesh screens within the pack, and after filtration, a total of 34 individual filaments were created at the spinneret orifice outlets. These 34 resulting filaments were cooled in an ambient air quench zone using simple cross flow air quenching, given an aqueous oil emulsion (10% oil) finish, and then combined in a guide approximately eight feet (˜7 meters) below the spin pack to produce a yarn. The 34 filament yarn was pulled away from the spinneret orifices and through the guide by a roll with an idler roll turning at approximately 800 meters per minute. From these rolls the yarn was taken to a pair of rolls also at 800 meters per minute, then through a steam jet at 140° C., then to a pair of rolls at 2550 meters per minute heated at 120° C., then to a pair of rolls at 2570 meters per minute heated to 140° C. then to a pair of let down rolls and to the windup unit (Barmag SW 6) to give a draw ratio of 3.2×.

### Example 4

Fibers were produced according to the general procedure using tin(II) ethylhexanoate as additive.

### Example 5

Fibers were produced according to the general procedure using tin(II) ethylhexanoate and zinc oxide as additives.

### Example 6

Fibers were produced according to the general procedure using tin(II) ethylhexanoate and zinc stearate as additives.

### Comparative Example E

This was a control run using native PPS. Fibers were produced according to the general procedure except that the dried PPS polymer mixture was fed to the extruder without any additives.

### Comparative Example F

Fibers were produced according to the general procedure using zinc stearate as additive.

TABLE 5
Compositions Used to Spin PPS Fiber Samples

| | | Additive Amount(s) |
|---|---|---|
| Sample | Additive(s) | In parts by weight |
| Example 4 | tin(II) | 0.5 |
| | ethylhexanoate | |
| Example 5 | tin(II) | 0.085 |
| | ethylhexanoate | |
| | + zinc oxide | 0.185 |
| Example 6 | tin(II) | 0.34 |
| | ethylhexanoate | |
| | + zinc stearate | 0.66 |
| Comp Ex E | — | — |
| Comp Ex F | zinc stearate | 1 |

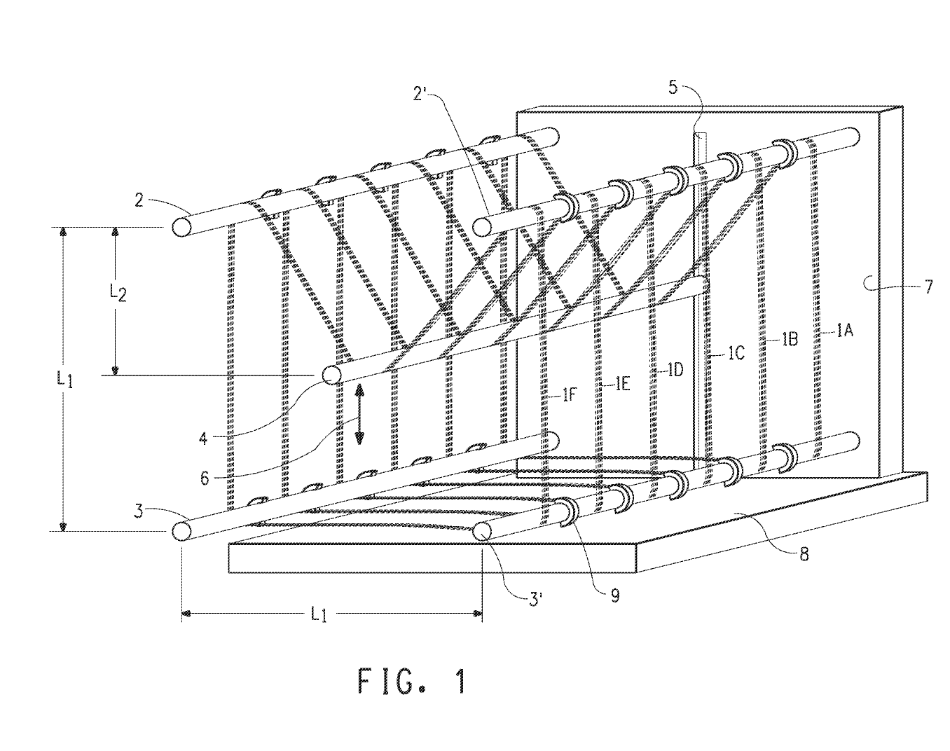

Samples of the fibers were then aged in air in a convection oven with forced air circulation, using the following method. For each fiber sample, 50 meters of fiber was wound to form a loop having a circumference of about 1 meter, Referring to FIG. 1, the loop 1A was placed on a frame consisting of five aluminum rods (2, 2′, 3, 3′, 4), each about ¼ inch (6 mm) in diameter and at least 12 inches (30 cm) in length, attached to a common support having a back 7 and a bottom 8 as shown in FIG. 1, where L1 is approximately 8 inches (20 cm) and L2 is approximately 3 to 4 inches (7.5 cm to 10 cm). The loop was placed over the top of rods 2 and 2′ and under the bottom of rods 3 and 3′. The loop was also placed under rod 4, which was then moved up or down along rail 5 as shown by the directional arrow 6 to pull the fiber loop just barely taut. Rod 4 was then fixed in place for the duration of the aging test. Up to six fiber loops (1A through 1F) were put on the frame at the same time, with wire clips 9 placed between each loop to keep the loops in place. Clips 9 need not be used on both the upper and lower rods in all embodiments, however.

The frame containing the fiber loops was placed inside a Blue M convection oven preheated to 250° C. Samples aged for different lengths of time in air were aged sequentially, not concurrently. After the appropriate amount of aging time, the frame with its fiber loops was removed from the oven and the fiber loop(s) removed for molecular weight measurements. The molecular weights of the samples were also measures prior to aging in air to provide data for comparison. Results are shown in Table 6.

TABLE 6
Molecular Weight Data for PPS Fiber Samples Aged in Air at 250° C.

| | | | | 1 h MW | MW after 5 | 5 Day MW | MW after 10 | 10 Day MW |
|---|---|---|---|---|---|---|---|---|
| | | Initial MW | MW after 1 | Retention | days | Retention | days | Retention |
| Sample | Additive(s) | (g/mol) | h (g/mol) | (%) | (g/mol) | (%) | (g/mol) | (%) |
| Example 4 | tin(II) | 57,000 | 50,000 | 88 | 48,000 | 84 | Insoluble * | NA |
| | ethylhexanoate | | | | | | | |
| Example 5 | tin(II) | 57,000 | 52,000 | 91 | 53,000 | 93 | Insoluble * | NA |
| | ethylhexanoate + | | | | | | | |
| | zinc oxide | | | | | | | |
| Example 6 | tin(II) | 58,000 | 54,000 | 93 | 53,000 | 91 | 83,000 | 143 |
| | ethylhexanoate + | | | | | | | |
| | zinc stearate | | | | | | | |
| Comp Ex E | — | 59,000 | 46,000 | 78 | 71,000 | 120 | Insoluble * | NA |
| Comp Ex F | zinc stearate | 58,000 | 50,000 | 86 | 48,000 | 83 | 62,000 | 107 |

* At least a portion of the sample was insoluble.

The higher percent retention values for Examples 1, 2, and 3 after 1 hour of aging in air at 250° C. show that the PPS fibers comprising tin ethylhexanoate exhibit lower molecular weight loss than does the control, Comparative Example E (native PPS). Examples 2 and 3, both of which comprise ethylhexanoate and a zinc compound, have 91% and 93% molecular weight retention, compared to 88% for PPS fibers comprising only tin ethylhexanoate (Example 1). All these fiber samples show better molecular weight retention at 1 hour than do Comparative Example F which contains zinc stearate.

After 5 days of aging in air at 250° C., Comparative Example E has clearly increased in molecular weight (120% MW retention), whereas all the samples containing additives have either gone down slightly in molecular weight or have increased only slightly in molecular weight. Thus, the samples containing additives show better molecular weight retention than the control.

After 10 days of aging in air at 250° C., some of the samples contained insoluble fractions and their molecular weight could not be determined. The insoluble fractions make it difficult to determine whether the molecular weight measured for the other samples was representative of the actual molecular weight.

The fiber data demonstrates that the combination of tin(II) ethylhexanoate and zinc stearate provides better thermal and thermo-oxidative stability than the native PPS (Comparative Example E).

Although particular embodiments of the present invention have been described in the foregoing description, it will be understood by those skilled in the art that the invention is capable of numerous modifications, substitutions, and rearrangements without departing from the spirit of essential attributes of the invention. Reference should be made to the appended claims, rather than to the foregoing specification, as indicating the scope of the invention.

What is claimed is:

1. A method to improve the thermal stability of a polyarylene sulfide, the method comprising combining a polyarylene sulfide with at least one tin additive comprising a branched tin(II) carboxylate selected from the group consisting of Sn(O₂CR)₂, Sn(O₂CR)(O₂CR′), Sn(O₂CR)(O₂CR″), and mixtures thereof, were the carboxylate moieties O₂CR and O₂CR′ independently represent branched carboxylate anions and the carboxylate moiety O₂CR″ represents a linear carboxylate anion.

2. The method of claim 1, wherein the additive further comprises a linear tin(II) carboxylate Sn(O₂CR″), where R″ is a primary alkyl group comprising from 6 to 30 carbon atoms.

3. The method of claim 2, wherein the sum of the branched carboxylate moieties O₂CR+O₂CR′ is at least about 25% on a molar basis of the total carboxylate moieties O₂CR+O₂CR′+O₂OR″ contained in the additive.

4. The method of claim 1, wherein the tin(l) carboxylate comprises Sn(O₂CR)₂, Sn(O₂CR)(O₂CR′), or mixtures thereof, and the radicals R or R′ independently or both have a structure represented by Formula (I), 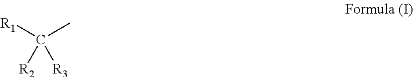
wherein R₁, R₂, and R₃ are independently:
H;
a primary, secondary, or tertiary alkyl group having from 6 to 18 carbon atoms, optionally substituted with fluoride, chloride, bromide, iodide, nitro, hydroxyl, and carboxyl groups;
an aromatic group having from 6 to 18 carbon atoms, optionally substituted with alkyl, fluoride, chloride, bromide, iodide, nitro, hydroxyl, and carboxyl groups; and
a cycloaliphatic group having from 6 to 18 carbon atoms, optionally substituted with fluoride, chloride, bromide, iodide, nitro, hydroxyl, and carboxyl groups;
with the proviso that when R₂ and R₃ are H, R₁ is:
a secondary or tertiary alkyl group having from 6 to 18 carbon atoms, optionally substituted with fluoride, chloride, bromide, iodide, nitro, hydroxyl, and carboxyl groups;
an aromatic group having from 6 to 18 carbons atoms and substituted with a secondary or tertiary alkyl group having from 6 to 18 carbon atoms, the aromatic group and/or the secondary or tertiary alkyl group being optionally substituted with fluoride, chloride, bromide, iodide, nitro, hydroxyl, and carboxyl groups; and
a cycloaliphatic group having from 6 to 18 carbon atoms, optionally substituted with fluoride, chloride, bromide, iodide, nitro, hydroxyl, and carboxyl groups.

5. The method of claim 4, wherein the radicals R or R″ or both have a structure represented by Formula (I), and R₃ is H.

6. The method of claim 1, wherein the tin(II) carboxylate comprises Sn(O₂CR)₂, Sn(O₂CR)(O₂CR′), or mixtures thereof, and the radicals R or R′ or both have a structure represented by Formula (II), 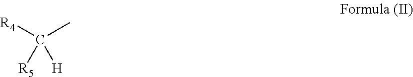
wherein
R₄ is a primary, secondary, or tertiary alkyl group having from 4 to 6 carbon atoms, optionally substituted with fluoride, chloride, bromide, iodide, nitro, and hydroxyl groups; and
R₅ is a methyl, ethyl, n-propyl, sec-propyl, n-butyl, sec-butyl, or tert-butyl group, optionally substituted with fluoride, chloride, bromide, iodide, nitro, and hydroxyl groups.

7. The method of claim 6, wherein the tin(II) carboxylate comprises Sn(O₂CR)₂, and R has a structure represented by Formula (II), where R₄ is n-butyl and R₅ is ethyl.

8. The method of claim 1, further comprising at least one zinc(II) compound and/or zinc metal.

9. The method of claim 8, wherein the zinc(H) compound comprises zinc stearate, the additive comprises Sn(O₂OR)₂, and R has a structure represented by Formula (II) 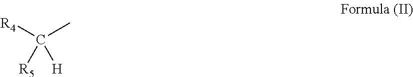
where R₄ is n-butyl and R₅ is ethyl.

10. The method of claim 8, wherein the zinc(H) compound and/or zinc metal is present at a concentration of about 10 weight percent or less, based on the weight of the polyarylene sulfide.

11. The method of claim 1, wherein the polyarylene sulfide is polyphenylene sulfide.
